(19) United States
(12) Patent Application Publication
(10) Pub. No.: US 2018/0215349 A1
(43) Pub. Date: Aug. 2, 2018

(54) METHOD FOR MONITORING THE USE OF A WIPER SYSTEM OF A MOTOR VEHICLE

(71) Applicant: Valeo Systèmes d'Essuyage, Les Mesnil Saint Denis (FR)

(72) Inventor: Nathalie Laloi, Issoire (FR)

(73) Assignee: Valeo Systèmes d'Essuyage, Le Mesnil Saint Denis (FR)

(21) Appl. No.: 15/886,237

(22) Filed: Feb. 1, 2018

(30) Foreign Application Priority Data
Feb. 2, 2017 (FR) 1750895

(51) Int. Cl. B60S 1/08; B60S 1/38; B60S 1/04

(52) U.S. Cl. CPC B60S 1/0818; B60S 2001/3844; B60S 1/0486; B60S 1/38

(57) ABSTRACT

The invention relates to a method 100 for monitoring the use of a wiper system of a motor vehicle 1, comprising the following steps:
a step of collecting at least one item of data relating to the triggering of the wiper system 10,
a step of collecting at least one item of data relating to the vehicle 1 and/or to its environment,
a step of transforming at least one of the items of data collected in the previous steps into a value, termed monitoring value,
a step of comparing the monitoring value with a value, termed predetermined threshold value,
a step of recording at least one of the collected items of data when the monitoring value reaches or exceeds the predetermined threshold value.

The invention also relates to a wiper system 10 comprising a control unit designed to implement the method such as described above.

### TECHNICAL FIELD OF THE INVENTION

The invention relates to a method for monitoring the use of a wiper system of a motor vehicle. The invention also relates to a control unit designed to implement such a method.

### TECHNICAL BACKGROUND OF THE INVENTION

Devices for monitoring the wear of wiper devices are known. In particular, the applicant has already proposed, in application WO-A1-2013/159943, a method for estimating the state of wear of a windscreen wiper blade on the basis of a coefficient of friction of the blade on the windscreen of a motor vehicle. The coefficient of friction is calculated on a dry windscreen, and its value is compared with a threshold value in order to determine the state of wear of the blade. This type of method is effective for detecting effective wear of the windscreen-wiper device.

However, there is a need to be able to alert a user of the motor vehicle before the deterioration of the wiper system.

### BRIEF SUMMARY OF THE INVENTION

One of the objects of the invention is to meet this need. The invention thus proposes a method for monitoring the use of a wiper system of a motor vehicle, comprising the following steps:
a step of collecting at least one item of data relating to the triggering of the wiper system,
a step of collecting at least one item of data relating to the vehicle and/or to its environment,
a step of transforming at least one of the items of data collected in the previous steps into a value, termed monitoring value,
a step of comparing the monitoring value with a value, termed predetermined threshold value,
a step of recording at least one of the collected items of data when the monitoring value reaches or exceeds the predetermined threshold value.

According to other features of the invention, which may be taken together or separately:
the monitoring value is compared with a matrix of predetermined threshold values,
the matrix of predetermined threshold values is stored on a server remote from the motor vehicle, the comparison step comprising a sub-step of connecting, in particular via the Internet, to said server,
the predetermined threshold value(s) are stored on a server remote from the motor vehicle, the comparison step comprising a sub-step of connecting, in particular via the Internet, to said server,
the at least one item of data relating to the vehicle and/or to its environment comprises one or more items of data from among the geographical position of the vehicle, the weather conditions, the presence of rain or snow, the external temperature, the level of a windscreen washer fluid reservoir, the date, the time, the type of windscreen wiper blades, the average lifetime of the windscreen wiper blades and the angular pivoting range of the windscreen wiper blades,
the at least one collected item of data is recorded in a storage module of the wiper system,
the method comprises a step of deleting the collected data and/or the monitoring value when the monitoring value neither reaches nor exceeds the corresponding predetermined threshold value,
the method comprises a step of generating a warning signal, in particular destined for a user of the motor vehicle, when the monitoring value reaches or exceeds the corresponding predetermined threshold value,
the warning signal is sent to a mobile telephone of the user,
the method furthermore comprises a step of displaying the warning signal on the dashboard of the motor vehicle,
the method comprises a step of displaying the warning signal on an on-board screen of the motor vehicle.

The invention also relates to a wiper system comprising a control unit designed to implement the above method.

### BRIEF DESCRIPTION OF THE FIGURES

Other features and advantages of the invention will become apparent from reading the following detailed description, for an understanding of which reference is made to the appended drawings, in which:

FIG. 1 is a schematic view of a wiper system for a motor-vehicle windscreen;

FIG. 2 is a flow chart of an exemplary method, according to the invention, for monitoring the use of the wiper system illustrated in FIG. 1.

### DETAILED DESCRIPTION OF THE FIGURES

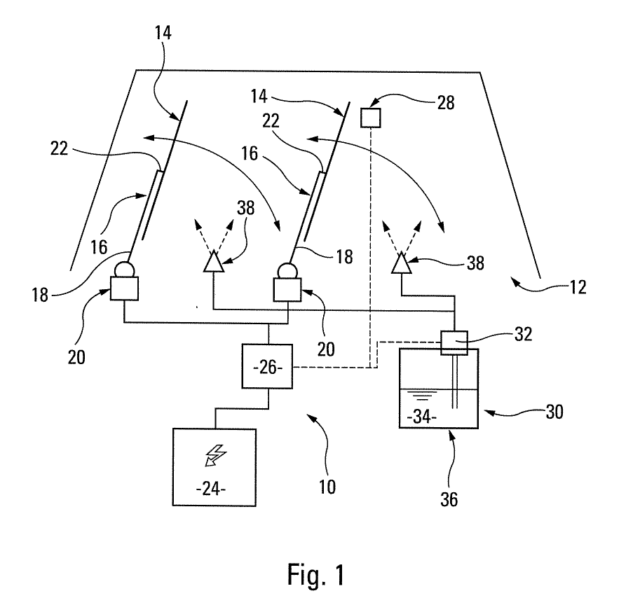

As illustrated in FIG. 1, the wiper system 10 in this case comprises two windscreen wiper blades 14. Each windscreen wiper blade 14 is borne by a blade holder 16, also commonly called a windscreen wiper arm or driving arm.

In a known manner, not shown in detail, each windscreen wiper blade 14 includes at least one wiper strip, which is a flexible strip made of elastomeric, natural or synthetic material and a lower edge of which, with a longitudinal orientation in the longitudinal general direction of the windscreen wiper blade 14, interacts with the outer surface of the windscreen 12 so as to clean and/or wipe the latter.

A proximal end 18 of each blade holder 16 is linked to a drive motor 20, whereas a distal end 22 of each blade holder 16 is linked to the windscreen wiper blade 14 that it bears.

Each drive motor 20 is designed to drive the blade holder 16 so as to wipe in an alternating pivoting motion, or a cyclical rotating motion, in a portion of a circular arc, about a pivot or rotational axis the general orientation of which is substantially orthogonal to the longitudinal general orientation of the blade holder 16.

In a known manner, each drive motor 20 includes an output shaft, not shown, that transmits a drive torque to the associated blade holder 16, directly or for example by way of a linkage.

Each drive motor 20 is for example an electric motor, and the drive motors 20 are linked to an electric power source 24, such as for example an accumulator battery of the vehicle or an alternator.

Each drive motor 20 is for example linked to the electric power source 24 by way of a unit 26 for controlling and supervising the wiper system 10.

The control and supervision unit 26 is designed and configured in particular to manage the operation of the wiper system 10 according to a plurality of predefined use programs, for example by supervising the rotational driving speed of the blade holders 16 by regulating the current supplied to the drive motors 20, for a given value of the supply voltage of the drive motors 20 supplied by the electric power source 24.

More precisely, the control and supervision unit 26 comprises for example an input interface, a data memory, a program memory, a computer, an output interface and at least one communication bus by way of which the input and output interfaces, the data and program memories and the computer communicate with one another.

The control and supervision unit 26 is for example configured to implement a method intended to monitor the use of the wiper system 10 of a motor vehicle. An exemplary method 100 is described in more detail hereinafter.

The input and/or output interfaces are for example linked to a user interface arranged in the user's passenger compartment. The user interface may for example comprise a touchscreen.

The input interface may furthermore be linked to means that are configured to measure the power consumption or the output torque of at least one motor 20 during operation. As a variant, the means are for example configured to measure the frictional torque of the windscreen wiper blade 14 on the windscreen 12 or the coefficient of friction of the windscreen wiper blade 14 on the windscreen 12.

By way of addition and without limitation, the wiper system 10 also comprises a rain sensor 28 that is linked to the control and supervision unit 26, in particular via the input interface.

The wiper system 10 also comprises a device 30 for cleaning the outer surface of the windscreen, which device includes a pump 32 that is linked to the control and supervision unit 26, in particular via the output interface, and to the electric power source 24, and which device is designed to draw windscreen washer fluid 34 from a reservoir 36 and convey it as far as means for projecting the fluid onto the outer surface of the windscreen 12, these projection means for example being nozzles 38 arranged on the bonnet of the motor vehicle or else borne by the windscreen wiper blades 14 or else by the blade holders 16. The device 30 for cleaning the outer surface of the windscreen makes it possible to implement a cleaning function of the wiper system 10.

The reservoir 36 is for example equipped with a level sensor designed in particular to detect when the reservoir 36 is empty.

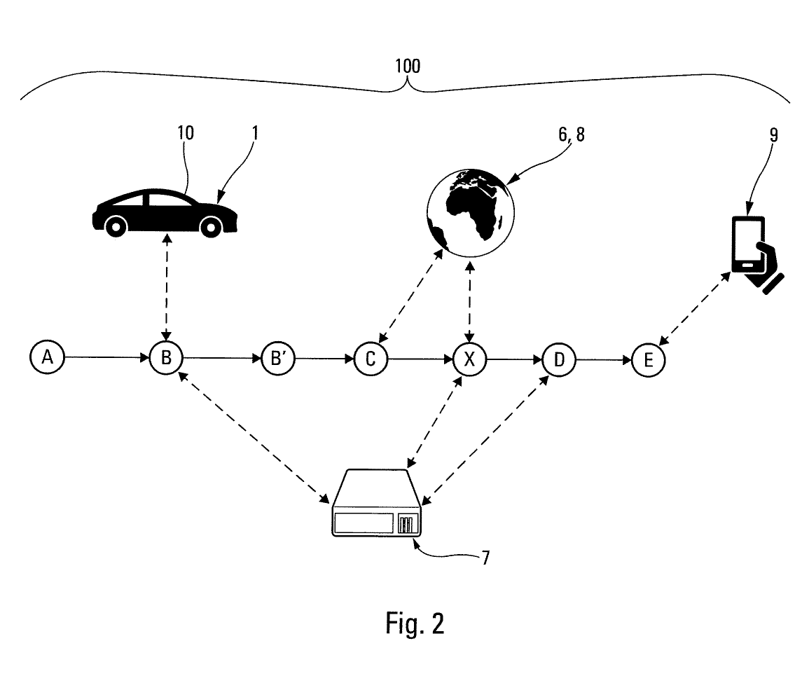

As illustrated in FIG. 2, the method 100 makes it possible to detect abnormal use of the wiper system 10 by comparing the conditions of use of the wiper system 10 with a pre-established list of abnormal situations.

The method 100 comprises all or some of the following steps, in particular in succession and in this order:

a step A of collecting one or more items of data relating to the triggering of the wiper system 10,
a step B of collecting one or more items of data relating to the vehicle 1 and/or to its environment,
a step B′ of transforming at least one of the items of data collected in the previous steps, termed monitoring data, into one or more values, termed monitoring values,
a step C of comparing the monitoring values with values, termed predetermined threshold values, each of the monitoring values being compared with the corresponding predetermined threshold value,
a step D of recording the monitoring data when some of the monitoring values reach the corresponding threshold value.

It will be noted that the method 100 may furthermore comprise a step X of collecting external monitoring data.

In addition, the method 100 may also comprise a step E of warning a user of the motor vehicle when an abnormal situation of use of the wiper system 10 is detected.

Step A corresponds to a step of detecting an activation of the wiper system 10. It will be noted that the activation of the wiper system 10 targeted in this step A may be for example:
either an activation triggered directly by the user,
or an automatic activation, in particular after detection of rain by the rain detector of the motor vehicle.

The detection of the activation of the wiper system 10 corresponds in this case to the first step of the method 100.

The data relating to the vehicle 1 and/or to its environment and targeted in step B are termed internal data. In other words, the data relating to the vehicle 1 and/or to its environment and targeted in step B are data that are accessible directly from the motor vehicle 1. In other words again, the internal data are data that may be provided by the vehicle itself, in particular by sensors of the motor vehicle. In particular, the internal data do not require an Internet connection to be collected during this step B.

The internal data comprise for example:
the geographical position of the vehicle when using the wiper system 10, such as provided for example by a GPS sensor of the motor vehicle 1,
the detection of the use of the windscreen cleaning function,
the detection of the stoppage of the wiper system 10,
the presence or the absence of rain when using the wiper system, detected by the rain sensor 28 of the motor vehicle 1,
the humidity level when using the wiper system 10, measured by a humidity detector of the motor vehicle 1,
the external temperature when using the wiper system 10, measured by a temperature sensor of the motor vehicle 1,
the level of the reservoir 36 detected by the level sensor,
the date and time of use of the wiper system 10, indicated by an internal clock of the motor vehicle 1,
the type of windscreen wiper blades 14 and/or their average lifetime,
the travelling speed of the motor vehicle 1 when using the wiper system 10,
the angular pivoting range of the windscreen wiper blades 14.

The data collected in step B are for example stored temporarily in a storage module 7 positioned in the motor vehicle 1.

It will furthermore be noted that the various sensors of the motor vehicle 1, in particular the humidity and rain sensors 28 or even the temperature sensor, enable an initial estimation of the weather conditions with which the motor vehicle 1 is faced. As will be seen hereinafter, these internal data relating to the weather conditions, termed internal weather data, may optionally be confirmed or invalidated by what are termed external weather data that are collected during step X.

It will moreover be noted that the information relating to the type of windscreen wiper blades 14 and to their average lifetime are in this case stored in the motor vehicle 1. This information may have been provided when the windscreen wiper blades 14 were installed by a car manufacturer, by a repairer or even by the user of the motor vehicle 1 himself.

Step X consists in collecting external data. The external data are data that are not directly accessible from the motor vehicle 1. In other words, the external data are neither generated nor provided by the sensors of the motor vehicle. The external data are in this case data that originate for example from a server 8 situated remotely from the motor vehicle, said server 8 being accessible via an Internet connection.

It will be noted that the external data collected in step X are for example stored temporarily in the storage module 7.

In this case, the external data comprise in particular information relating to the weather conditions, termed ‘external weather data’ hereinafter. In particular, the external weather data correspond to the weather conditions in which the motor vehicle 1 was travelling at the instant when the wiper system 10 was activated.

In order to recover these external weather data, it is possible to use some of the internal data collected in step B, including the date, the time and the geographical position of the motor vehicle 1. More particularly, the external weather data may be obtained by interrogating the server 8 on the basis of the internal data collected in step B in order to obtain the weather conditions when using the wiper system 10.

It will be noted that the internal data collected in step B and the external data collected in step X constitute data, termed monitoring data, for the motor vehicle. In other words, ‘monitoring data’ is the name given to the data collected in each of steps B and X.

Step C is implemented after step B. It will be noted in this case that the monitoring data compared during step C might not contain internal data, in particular in the case where step C is implemented before step X is implemented. As a variant, the monitoring data compared during step C comprise internal data and external data, in particular in a case where step C takes place after steps X and B.

In step C, the monitoring data are compared with values, termed predetermined threshold values. The predetermined threshold values in this case comprise pre-recorded values of parameters of the motor vehicle 1 and of its environment, corresponding to situations in which use of the wiper system 10 is discouraged as this promotes abnormal deterioration thereof.

In other words, the predetermined threshold values correspond for example to a list of values of parameters or of combinations of values of parameters that indicate an abnormal situation of use of the wiper system 10. By way of illustration, there are listed below, in a nonlimiting manner, a few examples of predetermined threshold values or of combinations of predetermined threshold values that correspond to abnormal use of the wiper system 10:
activation of the windscreen cleaning function AND windscreen washer fluid reservoir 36 empty,
external temperature below 3 degrees Celsius AND rain present,
drive motor of the wiper system 10 blocked,
abnormally low angular pivoting range of one of the windscreen wiper blades 14.

When there is a correspondence between the monitoring data and the predetermined threshold values, this means that the wiper system 10 is potentially being used in an abnormal manner. Step C therefore makes it possible to detect situations that promote deterioration of the wiper system 10, by comparing the monitoring data with the predetermined threshold values.

The predetermined threshold values may for example be stored in the form of a matrix of values. ‘Matrix of values’ is understood to mean a database, a table, a list or even a chart. It will be noted that the predetermined threshold values are for example stored directly in the storage module 7 that is positioned in the motor vehicle 1.

As a variant, the predetermined threshold values are stored remotely from the motor vehicle, for example on a server 6 accessible via the Internet. In this case, step C comprises a sub-step of connecting to said server 6. Once the connection has been established, it is then possible to compare the monitoring data with the predetermined threshold values.

Once the monitoring data have been compared with the predetermined threshold values, the monitoring data are classified into one or the other of the following categories:
A first category comprises the monitoring data corresponding to an abnormal situation of use of the wiper system 10.
A second category comprises the monitoring data that do not correspond to abnormal situations of use of the wiper system 10.

Step B′ is advantageously implemented before step C. Step B′ consists in transforming all or some of the monitoring data into values, termed monitoring values. In other words, step B′ consists in assigning a value, in particular a numerical value, to each of the items of monitoring data. Thereafter, step C then consists of a comparison between the predetermined threshold values and the monitoring values. When at least one of the monitoring values reaches or exceeds a corresponding predetermined threshold value, this means that the wiper system 10 is being used in abnormal conditions.

Step D in this case follows step C. When an abnormal situation of use of the wiper system 10 has been detected, then step D consists in recording all or some of the monitoring data. The monitoring data are then stored for example in the storage module 7 of the motor vehicle 1. It will be noted that the monitoring data may optionally be stored in the form of monitoring values.

The storage of the monitoring data advantageously makes it possible to monitor, over time, the use of the wiper system 10 by the user of the motor vehicle. It will be noted that the stored monitoring data may for example be used by an insurance provider, a car equipment manufacturer, a car dealer and/or the manufacturer of the motor vehicle upon a customer return and/or to analyse parts under warranty, in particular in order to check that the user has indeed complied with any instructions for using the wiper system 10. Moreover, storing the monitoring data also makes it possible, as will be seen hereinafter, to alert the user to abnormal and repeated use that he may make of the wiper system 10.

By contrast, when no abnormal situation of use of the wiper system 10 has been detected during step C, then the monitoring data are not retained. Deleting or not retaining the monitoring data then makes it possible to limit the unnecessary occupation of the storage module 7.

It will be noted that step X, described above, may be implemented:
after step B and before step C, or
after step C and, advantageously, only in the case where an abnormal situation of use of the wiper system 10 has been detected.

For example, step X may be used to confirm or invalidate the internal weather data collected during step B. For example, if one of the internal items of data collected in step B indicates that the external temperature is below 3 degrees Celsius, then the external weather data may make it possible to confirm or to invalidate this information. Likewise, the external weather data may make it possible to confirm or to invalidate the internal weather data supplied by the rain sensor 28.

In the case where step X is implemented after step D, it is then possible, when the external weather data invalidate the internal weather data, to contemplate deleting, from the storage module 7, the monitoring data that were stored there beforehand. By contrast, in the case where the external weather data confirm the internal weather data, then the monitoring data are retained.

The method furthermore comprises a warning step E, which consists in producing a warning signal when an abnormal situation of use of the wiper system 10 has been detected.

The warning step E consists in this case in sending a warning signal, in particular destined for the user of the vehicle and/or for an individual responsible for maintaining the windscreen wiper blade 14 and/or for an insurance provider. The warning signal is for example an information signal for the purpose of providing an alert regarding abnormal use of the wiper system 10.

The warning signal may for example be displayed on the user interface. The warning signal is for example displayed immediately on said user interface.

The warning signal may also be transmitted and displayed on any remote communication device available to the user or a maintenance service, for example on a mobile telephone 9 of the user.

1. A method for monitoring the use of a wiper system of a motor vehicle, comprising:
collecting at least one item of data relating to the triggering of the wiper system;
collecting at least one item of data relating to the motor vehicle and/or to its environment;
transforming at least one of the items of data collected in the previous steps into a value, termed monitoring value;
comparing the monitoring value with a value, termed predetermined threshold value; and
recording at least one of the collected items of data when the monitoring value reaches or exceeds the predetermined threshold value.

2. The method according to claim 1, wherein the monitoring value is compared with a matrix of predetermined threshold values.

3. The method according to claim 2, wherein the predetermined threshold values are stored on a server remote from the motor vehicle, the comparison comprising a sub-step of connecting, via the Internet, to said server.

4. The method according to claim 1, wherein the at least one item of data relating to the motor vehicle and/or to its environment comprises one or more items of data from among the geographical position of the motor vehicle, the weather conditions, the presence of rain or snow, the external temperature, the level of a windscreen washer fluid reservoir, the date, the time, the type of windscreen wiper blades, the average lifetime of the windscreen wiper blades and the angular pivoting range of the windscreen wiper blades.

5. The method according to claim 1, wherein the at least one collected item of data is recorded in a storage module of the wiper system.

6. The method according to claim 1, further comprising deleting the collected data and/or the monitoring value when the monitoring value neither reaches nor exceeds the predetermined threshold value.

7. The method according to claim 1, further comprising generating a warning signal destined for a user of the motor vehicle when the monitoring value reaches or exceeds the corresponding predetermined threshold value.

8. The method according to claim 7, wherein the warning signal is sent to a mobile telephone of the user.

9. The method according to claim 7, further comprising displaying the warning signal on the dashboard of the motor vehicle.

10. The method according to claim 7, further comprising displaying the warning signal on an on-board screen of the motor vehicle.

11. A wiper system of a motor vehicle, comprising a control unit designed to implement the method according to claim 1.
